(19) United States
(12) Patent Application Publication
(10) Pub. No.: US 2014/0102617 A1
(43) Pub. Date: Apr. 17, 2014

(54) METHOD FOR DETECTING THE TRANSVERSE POSITION OF A PACKING MATERIAL, IN PARTICULAR A FILM WRAPPING

(71) Applicants: Hansjoerg Hutter, Oberhallau (CH); Markus Wehrli, Schaffhausen (CH); Alfred Wipf, Jestetten (DE)

(72) Inventors: Hansjoerg Hutter, Oberhallau (CH); Markus Wehrli, Schaffhausen (CH); Alfred Wipf, Jestetten (DE)

(73) Assignee: ROBERT BOSCH GmbH, Stuttgart (DE)

(21) Appl. No.: 14/123,553

(22) PCT Filed: May 15, 2012
(86) PCT No.: PCT/EP2012/059047

§ 371 Date: Dec. 3, 2013

(30) Foreign Application Priority Data
Jun. 3, 2011 (DE) 10 2011 076 922.6

(51) Int. Cl. G01B 11/27

(52) U.S. Cl. CPC G01B 11/272
USPC 156/64; 356/620

(57) ABSTRACT

The invention relates to a method for detecting the transverse position of at least one sealing section (1, 2) on a packaging material (4), in particular a film wrapping, and/or the transverse position of the packaging material (4), wherein the packaging material (4) is displaced along a running direction (L), wherein the transverse position of the at least one sealing section (1, 2) or the packaging material (4) relative to the running direction (L) is detected by means of at least one sensor unit (5). The packaging material (4) comprises at least one cursor (7) by means of which the transverse position of the at least one sealing section (1, 2) or the packaging material (4) transverse to the running direction (L) is detected, wherein the shape of the cursor (7) changes with respect to a direction running in particular transverse to or at an angle to the running direction (L), wherein said change is detected by the sensor unit (5) and the transverse position of the packaging material (4) or the at least one sealing section (1, 2) is determined by means of the change.

### BACKGROUND OF THE INVENTION

The present invention relates to a method for detecting the transverse position of at least one sealing section on a packaging material, in particular a film wrapping, and/or the transverse position of the packaging material.

A tubular package is typically provided by a continuous film, wherein said film is molded to form a tube around a product to be packaged and is closed with a longitudinal sealing seam and two transverse sealing seams.

Vertical as well as horizontal tubular bag machines are known from the prior art.

The two longitudinal edges or peripheral regions of a continuous film are connected with a longitudinal sealing seam when the film is being molded to form a tube. The film inner sides of the longitudinal edges are brought together and joined to form a fin seal by a suitable sealing method. The longitudinal edges can also be brought together in an overlapping manner with the inner side and the outer side and joined to form a so-called lap seal. A plurality of sealing methods is known. For example, sealing layers of the film inner sides of the longitudinal edges can be joined from exposure to pressure and/or heat and/or ultrasonics. The problem in manufacturing such packagings is that the quality of the longitudinal sealing seam is dependent on the exact positioning of the overlap of the film peripheral regions making contact with one another. It is possible that the overlap is displaced on one side and a qualitatively poor sealing seam can thereby result because said sealing seam does not extend over the intended dimensions. In the worst case, the packaging can even remain open because there is no overlap in the region which was sealed. In addition, an image that is possibly imprinted on the film can have been displaced from the correct position which can result in the visual quality of the packaging being compromised.

Such a one-sided displacement of the overlap can result if the film is displaced in the transverse position thereof transversely to the running direction, or respectively the longitudinal direction, with respect to a target position in the device for forming the film tube. The film is then molded transversely offset to form a tube, whereby the longitudinal edges (peripheral regions) of the film do not completely overlap.

The quality of the sealing seams is generally tested on a random basis. In the event that the sealing seams do not meet the quality standards, all products produced since the last random test often have to be disposed of.

In known solutions, the transverse position of the film is for the most part detected prior to the film being formed into a tube and is corrected when inaccuracies occur. For the most part, the measurement takes place via the film edges. A disadvantage of such a solution is that the detection of the transverse position of the film edges is difficult and in part unreliable. A mechanical measurement of the transverse position is precarious because the film can be damaged. A measurement using a sensor is difficult and unreliable in particular in regard to transparent films.

A further disadvantage results from the fact that a distance of several meters can separate the measuring point and the actual seam and thus a possible later displacement of the film between the measurement and the sealing point cannot be controlled.

### SUMMARY OF THE INVENTION

Based on said prior art, the aim underlying the invention is to specify a method which overcomes the disadvantages of the prior art. In particular, a method and a corresponding device are intended to be specified which allow for a simple detection of a transverse position, i.e. a position of a packaging material transverse, that is perpendicular, to the longitudinal direction or the running direction along which the packaging material is displaced in a packaging machine.

Such an aim is met by a method according to the invention. A method serves accordingly to detect the transverse position of at least one sealing section on a packaging material, in particular a film wrapping, and/or the transverse position of the packaging material, wherein the packaging material is displaced along a running direction, wherein the transverse position constitutes the position transverse to the running direction, wherein the transverse position of the at least one sealing section or the packaging material is detected with at least one sensor unit. The packaging material comprises at least one cursor by means of which the transverse position of the at least one sealing section or the packaging material transverse to the running direction is detected, wherein the shape of the cursor changes with respect to a direction running in particular transverse to or at an angle to the running direction, wherein said change is detected by the sensor unit and the transverse position of the packaging material or the at least one sealing section is determined by means of the change.

A continuous film is preferably understood in this context by the term packaging material or film wrapping, said film being delivered to a forming device in which the film is molded around a product to form a tube. The term packaging material is thereby used independently of the actual state of the packaging material. As a result, the position of the unmolded packaging material as well as the position of the molded packaging material can be detected using the method according to the invention.

The longitudinal direction of the film corresponds to the direction in which the film extends and the running direction is that direction in which the packaging material or the film runs through the packaging machine. Longitudinal direction and running direction normally run in a collinear manner with respect to one another.

Sealing section refers to those regions in the proximity of the lateral edges of the packaging material which run parallel to the running direction of the packaging material. The two sealing sections of the packaging material are brought together in a manner described below and are sealed in said region. The sealing sections can be brought together such that the respective film inner sides touch, wherein a so-called fin seal is formed. The sealing sections can optionally be brought together so as to overlap; thus enabling the film outer side of the first seating section and the film inner side of the second sealing section to make contact. As a result, a so-called lap seal is formed.

By the term cursor, an identification marker on the packaging material can be understood which can be imprinted during manufacture of the film or in the packaging machine. The cursor is preferably recurrently imprinted on the packaging material, wherein a plurality of cursors is consecutively arranged. As an alternative, a mechanical structure, such as rills or self-adhesive labels, or else an electronically detectable structure, such as a magnetic structure, can be used.

The transverse position can be especially easily and reliably detected by means of the arrangement of such a cursor. In addition, a high degree of accuracy can be achieved depending on the configuration of the cursor.

In other words, the sensor unit is configured such that the transverse position of at least one of the sealing sections or of the packaging material is detected by means of the detection of a cursor arranged on the packaging material.

In a preferable manner, a first cursor arranged on the packaging material, in particular on a first sealing region, can be detected with a first sensor unit and a second cursor arranged on the packaging material, in particular on a second sealing region, with an additional sensor unit.

The cursor is preferably configured in such a way that a distance which corresponds to the length of the cursor in the running direction changes in conjunction with a change in distance from the lateral edge as viewed transversely with respect to the longitudinal direction, whereby the transverse position of the sealing section or of the packaging material is determined by detecting the distance which corresponds to the length of the cursor in the running direction.

The cursor has preferably at least one first detectable measuring edge and a second detectable measuring edge, wherein the two measuring edges run at an angle to each other so that the distance from the first measuring edge to the second measuring edge in the running direction changes in conjunction with a change in distance from the lateral edge as viewed transversely with respect to the running direction, wherein said transverse position of the sealing section or of the packaging material is determined by detecting the distance between the measuring edges. It can also be said that the distance from the first measuring edge to the second measuring edge in the running direction changes with a change in distance from the lateral edge transversely to the running direction.

At least one of the measuring edges preferably runs inclined or at an angle to the running direction of the packaging material. The other measuring edge is preferably perpendicular to the running direction.

The cursor is preferably the same identification marker which is used to detect the position longitudinal to the running direction. In a particularly preferable manner, one of the measuring edges is used to detect the position longitudinal to the running direction. In the case of printed films, the position of an image on the film web can thereby be positioned and controlled with respect to the transverse sealing seams.

As an alternative, the cursor comprises a plurality of stripes of different length which are arranged consecutively and at an angle, in particular transversely, with respect to the running direction, wherein the sensor unit detects a different number of stripes depending on the transverse position of the sealing section or of the packaging material and in so doing determines said transverse position of the sealing sections.

The term “sensor” or “sensor unit” is to be understood in such a way that physically one single sensor or a plurality of sensors can be used. For example, a plurality of sensors can also be arranged in parallel in order to detect the length of the cursor. The transverse position of the sealing sections is then determined from the combination of the individual sensor signals.

After detecting the transverse position of the sealing sections, the at least two sealing sections are preferably aligned via a positioning unit, wherein, by means of said positioning unit, the transverse position of the sealing sections relative to one another and/or relative to the at least one sensor unit is adjusted on the basis of the detection by means of the sensor unit; and/or wherein, if applicable, the two sealing sections are sealed by means of a sealing unit. After detecting the transverse position of the sealing sections, said transverse position can be advantageously compared to a target value and the result can be outputted to a user and/or one or a plurality of products can be discarded if an admissible deviation has been exceeded.

A positioning unit refers in this context to a device with which the position of the packaging material can be changed transversely to the running direction thereof and/or the position of the tube can be changed perpendicularly to the running direction and with respect to the machine parts which form the overlap of the sealing regions. The device can thereby consist of one or a plurality of units. The measured transverse position of the packaging material can be used for this purpose. In other words, it can be said that an overlapping of the sealing regions relative to one another and/or the position of the overlap perpendicular to the running direction can be corrected. This has the result that the position of the film edges can be adjusted relative to one another and the width of the sealing seam can be adjusted in the case of a fin seal. In the case of a lap seal, the position of the film edges relative to one another changes the width of the seal, and the displacement of the film transversely to the running direction changes the position of the seal transversely to the running direction.

In other words, said detected transverse position can be used for different purposes, such as for discarding faulty products, for providing information to the user, for statistical purposes and/or for the control of possible printers so that the printed image is correctly imprinted with respect to position. Further applications are also conceivable.

The transverse position of at least one lateral edge of the packaging material or the sealing sections is preferably detected with an additional sensor unit, wherein a signal can preferably be generated using the additional sensor unit if one of the lateral edges lies outside of a predefined tolerance field, wherein the signal can serve to adjust the transverse position of the packaging material or the sealing sections, or wherein a signal is generated using the additional sensor unit, which signal corresponds to the effective transverse position of the lateral edges, said signal being able to serve to adjust the transverse position of the packaging material or the sealing sections.

A device for carrying out a method according to the above description comprises a sensor unit, wherein the packaging material comprises at least one cursor by means of which the transverse position of the at least one sealing section or the packaging can be detected transversely to the running direction, wherein the shape of the cursor changes with respect to a direction running in particular transversely to or at an angle to the running direction, wherein said change can be detected by the sensor unit and the transverse position of the packaging material or the at least one sealing section can be determined by means of the change.

The invention can be used with vertical tubular bag machines, in which the film tube runs vertically and the products are filled after the tube has been formed, as well with horizontal tubular bag machines, in which the film tube runs horizontally and the tube is formed around the products.

### BRIEF DESCRIPTION OF THE DRAWINGS

Preferred embodiments of the invention are described below with the aid of the drawings which only serve to explain the invention and are not to be interpreted in a manner which limits the invention. In the drawings:

FIG. 1 shows a schematic view of a device for carrying out the inventive method for relatively aligning two sealing sections of a sealing point on a packaging according to a first embodiment;

FIG. 2 shows a schematic view of a film web to be sealed;

FIGS. 3a to 3c show views of FIG. 1, wherein the sealing sections are located at different positions;

FIG. 4 shows a schematic view of a device for carrying out the inventive method for relatively aligning two sealing sections of a sealing point on a packaging material according to a second embodiment;

FIG. 5 shows a possible embodiment of a sealing seam pursuant to FIG. 4;

FIG. 6 shows a schematic view of a device for carrying out the inventive method for relatively aligning two sealing sections of a sealing point on a packaging material according to a third embodiment;

FIG. 7 shows a schematic view of a film web to be sealed;

FIG. 8 shows different positions of cursors;

FIG. 9 shows a first embodiment of a cursor; and

FIG. 10 shows a second embodiment of a cursor.

### DETAILED DESCRIPTION

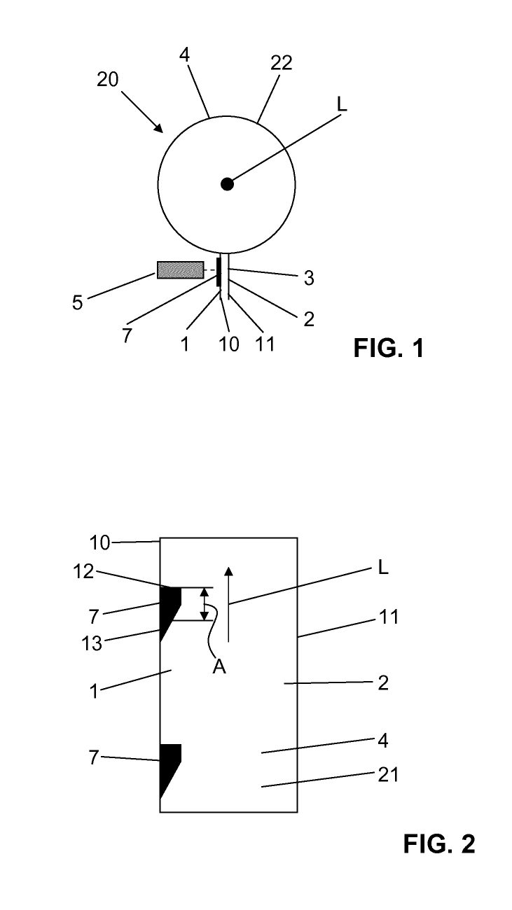

A device for carrying out the inventive method is shown in FIG. 1.

The detection of the transverse position of a first sealing section 1 with a second sealing section 2 of a packaging material 4 can be provided using the inventive device and method. Said method or device is advantageously used in the region of a sealing point of a packaging machine, wherein a sealing point occurs on the packaging material in the region of the sealing sections 1, 2. The detection of the transverse position thereby forms the basis for an alignment of the sealing sections 1, 2 to one another.

The packaging material 4 is preferably a film web 21 from which a tubular bag 20 is formed. The film web is guided along a running direction L, as indicated in FIGS. 1 and 2, through a packaging machine, wherein the inventive device constitutes a part of said packaging machine and is operated in accordance with the inventive method. The packaging machine can comprise a plurality of other stations, as, for example, a sealing station etc. The film web is thereby molded to form a tube, which is schematically depicted in FIG. 1 and is then provided along the running direction L of the film web with a sealing seam 3 formed parallel to said running direction L, which is perpendicular to the plane of the sheet in FIG. 1. Furthermore, two transverse sealing seams (not depicted) are then arranged perpendicularly to the running direction L, which seams seal the tubular bag.

During the sealing operation, it is important that the first sealing section 1 is aligned relative to the second sealing section 2 so that a good sealing takes place. One such good alignment can be achieved by detecting the transverse position of the packaging material, i.e. the position transverse or perpendicular to the running direction L, using the inventive method and a corresponding correction.

The device for detecting the transverse position of the two sealing sections 1, 2, which is shown in FIG. 1, essentially comprises a sensor unit 5 and optionally an alignment unit that is not depicted. The transverse position of at least one of the two sealing sections 1, 2 can be detected using the sensor unit 5; while the two sealing sections 1, 2 can be aligned relative to one another via the alignment unit with the aid of the information of the sensor unit 5. In so doing, said two sealing sections can correspondingly overlap and the sealing point 3 can be produced.

The transverse position of at least one of the sealing sections 1, 2 or of the packaging material itself is thus detected using the at least one sensor unit 5. In the present embodiment, the transverse position of the first sealing section 1 is detected. The position of the sealing sections is then aligned relative to the running direction L or else relative to one another by means of an optional positioning unit, wherein this alignment takes place on the basis of the detection of the transverse position by means of the sensor unit 5. The sensor unit 5 is thereby designed in such a way that said sensor unit detects the transverse position of at least one of the two sealing sections 1, 2 or of the packaging material 4 itself by detecting a cursor 7 arranged on the packaging material 4.

As a result, the transverse position of the sealing section 1 is thus detected by means of the cursor 7, which can also be referred to as a reference print, being scanned. With regard to FIG. 1, this means that the transverse position of the film edge 10 of the first sealing section 1 can be determined via the cursor 7 which likewise lies in the first sealing section 1.

A plurality of sensor units can also be arranged consecutively in order to detect the cursor 7.

By detecting the transverse position of the cursor 7, which is fixedly disposed or imprinted on the packaging material 4 or on the film web 21, the effective position, i.e. the actual position, of the first sealing section 1 or of the first edge 10 can be detected. On the basis of this detection, the actual transverse position of the first edge 10 can thus be corrected to the target transverse position. A preferred target transverse position is thereby shown in FIG. 1, wherein both sealing sections 1, 2 lie in this case exactly on top of each other. Such a transverse position is, for example, desired when producing a so-called fin seal.

It is furthermore important for the quality of the sealing that both sealing sections 1, 2 not only lie exactly on top of each other but are also guided exactly in the longitudinal direction through the sealing station, which is disposed downstream of the sensor unit 5 with respect to the movement in the longitudinal direction. In addition, the sensor unit 5 and the cursors are preferably configured in such a way that that the transverse position of the sealing sections 1, 2 can be detected relative to the sensor unit 5. In so doing, the sensor unit 5 provides data that the longitudinal sealing seam can be disposed substantially exactly at the desired location, whereby a good sealing seam can be provided. This has additionally the advantage that the sealing seam looks good visually and a non-printed part of the inside of a side edge 10, 11 is not visible.

In summary, the transverse position of the cursors 7 can be detected using the sensor unit 5, whereby it can be determined how the two sealing sections 1, 2 lie relative to one another and/or whereby it can be detected how the sealing sections 1, 2 lie relative to the running direction L or relative to the sealing device. Depending on the arrangement of the sensor unit, the transverse position of the film can be detected or measured prior to the formation of the tube or prior to the formation of the sealing seam; and/or the transverse position of the individual lateral edges 10, 11 can be detected or measured transversely to the running direction of the film.

The cursor 7 has a shape which changes with respect to a direction that runs particularly transversely or at an angle to the running direction L, wherein said change is detected by the sensor unit 5 and the transverse position of the packaging material 4 or of the at least one sealing section 1, 2 is determined by means of the change. The cursor 7 is preferably configured in such a way that a distance A of the cursor in the running direction changes in conjunction with a change in distance from the lateral edge 10, 11 as viewed transversely with respect to the running direction, whereby the transverse position of the sealing section 1, 2 or of the packaging material 4 is determined via the detection of the distance A. Such an embodiment is, for example, depicted in FIGS. 2, 8 and 9.

The cursor 7 can be designed in different ways. The cursor 7 can, for example, have the shape of an imprint on the surface 22 of the film web 21. The imprint can thereby be a usual surface printing, such as a logo. Said imprint thus relates to a constituent of the final packaging. The transverse position of the imprint is detected by measuring a defined region of the imprint. The cursor can also have the shape of a color-coded, brightness-coded or dot-coded design, of a magnetic structure, of a mechanical structure, of an imprint or of a self-adhesive label.

A cursor 7 is also preferably disposed in the region of the first sealing section 1, 2, as is depicted in FIGS. 1 and 2. The shape of the cursor is preferably configured in this case such that the measured value of the sensor corresponds to the amount of the film position that is transverse to the running direction L. To this end, the cursor 7 is configured in such a manner that a distance A, which corresponds to the length of the cursor in the running direction L, changes in conjunction with an increase in distance from the lateral edge 10, 11 as viewed transversely with respect to the longitudinal direction. By detecting the distance A, the transverse position of the sealing section 1,2 with respect to the running direction L can be determined.

The cursor 7 can also take on other functions, such as, for example, those of a centering marker for positioning a possible printed image on the packaging or the packaging material relative to the product to be packaged or relative to the transverse sealing seams. The cursor can also be a part of the printed image.

The cursor 7 preferably has at least one first detectable measuring edge 12 and a second detectable measuring edge 13, which run at an angle with respect to one another or at an angle with respect to the running direction L of the packaging material 4 so that the distance from the first measuring edge 12 to the second measuring edge 13 varies in a direction parallel to the lateral edge of the sealing section 1, 2, wherein the transverse position of the sealing section 1, 2 transverse to the running direction L can be determined by detecting the distance A between the measuring edges 12, 13. Hence, a positional displacement of the sealing section 1, 2 transversely to the running direction results in a different measured value when measuring the distance A.

In the present embodiment, the cursors 7 have the shape of a rectangular trapezoid. In this embodiment, the first measuring edge 12 which runs perpendicularly to the running direction of the film can, for example, additionally be used as a measuring edge for detecting the position of the film longitudinally to the running direction. Other types of a trapezoid are also conceivable. As an alternative, other geometric shapes can also be used. These include, for example, a triangle or even curved contours.

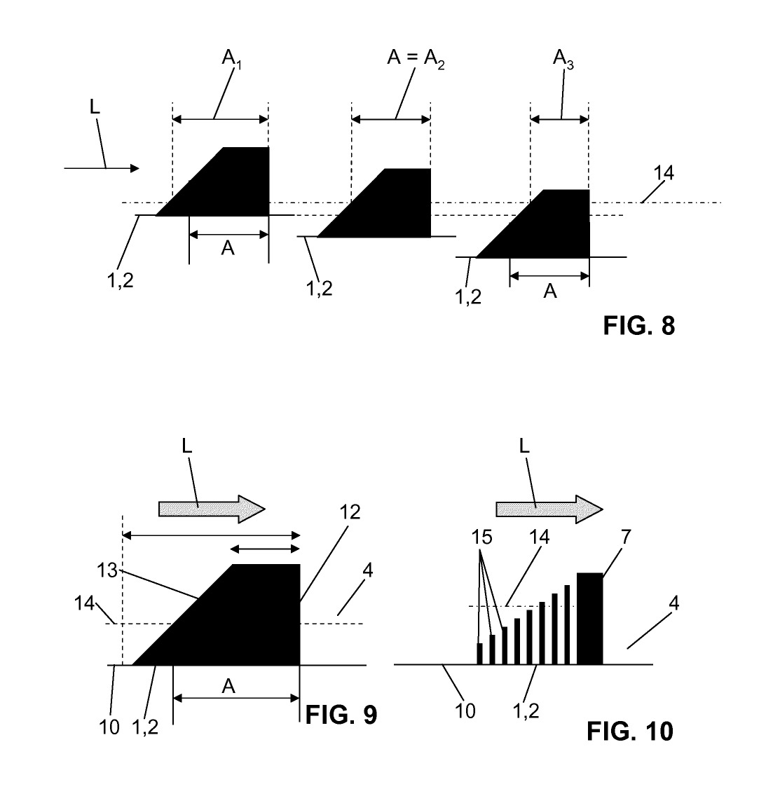

Further alternatives of the cursor 7 are shown in FIGS. 8, 9 and 10. Said cursors 7 can likewise be used in all of the embodiments described herein.

The measurement of the distance A is clarified in FIG. 8. The dashed-and-dotted line represents the scanning line of the sensor which runs parallel to the running direction of the film web.

In the diagram on the left-hand side, a distance A1 which represents the actual value is measured. The target value is, however, the distance A. Thus, a displacement of the sealing section 1, 2 or of the entire packaging material 4 transversely to the running direction L exists. The transverse position of the sealing section 1, 2 must therefore be corrected.

In the diagram in the middle, the distance A2 corresponds to the distance A. The actual value A2 is therefore equal to the target value and the transverse position of the sealing section 1, 2 is correct.

In the diagram on the right-hand side, a distance A3 which represents the actual value is measured. The target value is, however, the distance A. Hence, a displacement of the sealing section 1, 2 or of the entire packaging material 4 transversely to the running direction L exists. The transverse position of the sealing section 1, 2 must therefore be corrected.

With the aid of FIG. 9, the preferred form of the cursor 7 is now explained in the shape of a trapezoid. The trapezoid has a first measuring edge 12 and a second measuring edge 13. The first measuring edge 12 lies substantially perpendicularly to the running direction L of the packaging material 4, while the second measuring edge 13 lies at an angle to the running direction L. The distance A is measured at the height of the scanning line 14.

With the aid of FIG. 10, a further alternative embodiment of the cursor 7 is shown. In this case, the cursor comprises a plurality of stripes 15 of different lengths disposed consecutively in the running direction. In so doing, the sensor unit measures a different number of lines depending on the transverse position of the film, which in turn corresponds to an amount at which the film is transversely positioned.

The cursor 7 can be arranged at any desired location on the packaging material 4. An arrangement in a peripheral region, i.e. in the proximity of the lateral edge 10 or 11, of the packaging material 4 or the film web 21 is however preferred, such as is shown in FIG. 2. The peripheral region is typically the same as the sealing section 1, 2. It can thus be said that the cursor 7 is preferably arranged in the sealing section 1, 2.

The sensor unit 5 can be situated at different locations in the packaging machine. In the case of a film web, it is, for example, conceivable to dispose the sensor unit 5 upstream of the tube forming device as viewed in the running direction L; thus enabling the transverse position of the film web itself with respect to the running direction L to be detected. The sensor unit 5 can furthermore be disposed between the bag forming device and a sealing station; thus enabling the sealing sections 1, 2 to be detected.

In a particularly preferential manner, the sensor unit 5 is however disposed in the region of a sealing unit, which has the advantage that the positional deviation is measured at the point where the sealing sections 1, 2 are intended to be exactly aligned.

The sensor unit 5 preferably transmits a signal which corresponds to the deviation of the packaging material or the film web from the running direction L. Said signal can then be supplied to a positioning unit or a film control unit, wherein the packaging material 4 itself is aligned to the running direction or two sealing sections 1, 2 are aligned to one another. It can also be said that the packaging material 4 is aligned relative to the running direction or the sealing sections 1, 2 are aligned relative to one another on the basis of the detection by means of the sensor unit 5. Alternatively or additionally, said signal can be used to assess the quality of the longitudinal sealing seam in conjunction with a corresponding outputting of information. Further applications of said signal, such as the aligning of a printed image, which is applied by a printer directly in the packaging machine, are likewise conceivable.

The sensor unit can be an analog sensor which transmits an analog signal, such as, for example, a signal that corresponds to the effective position. As an alternative, a digital sensor can be used which transmits a digital signal with which it is determined whether or not the cursor lies in a corresponding region. For example, “1” if the cursor is detected or “0” if the cursor is not detected.

With respect to the embodiment depicted in FIGS. 1 and 2, it can in summary be stated that the transverse position of the packaging material 4 or of the film web transverse to the running direction L can be detected using a sensor unit 5 and a cursor 7 imprinted on the packaging material 4 or the film web. The detection can thereby take place both in the molded state when both sealing sections 1, 2 are disposed directly opposite one another, as is shown in FIG. 1, or else in the not yet molded state, as is depicted in FIG. 2.

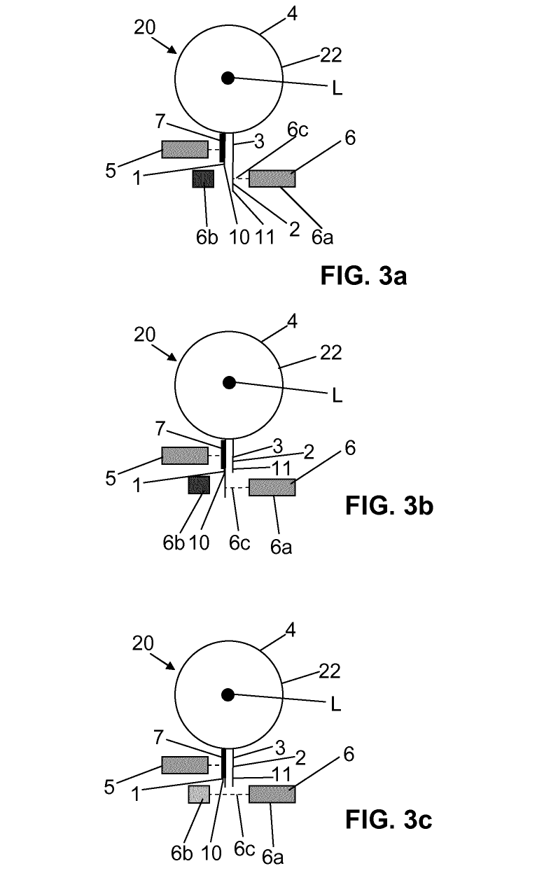

A further embodiment of the present invention is depicted in FIGS. 3a to 3c. The packaging material comprises in this case likewise two sealing sections 1, 2 and at least one cursor 7. The transverse position of the cursor 7 is detected by a first sensor unit 5 in accordance with the above description. In this case, the embodiment further comprises an additional sensor unit 6 with which the transverse position of at least one lateral edge 10, 11 of the packaging material 4 or the sealing section 1, 2 is detected. A signal can preferably be generated by the additional sensor unit 6 if one of the lateral edges 10, 11 lies outside of a predefined tolerance field, wherein the signal serves to adjust the transverse position of the packaging material 4 or the sealing sections 1, 2. The actual value can thus be matched to a target value.

The additional sensor unit 6 can, for example, be a light barrier with transmitter 6a which emits a light beam 6c and receiver 6b which receives the light beam 6c. The second sealing section 2 lies between sender 6a and receiver 6b in FIG. 3a. As a result, the light beam 6c from the transmitter 6a does not reach the receiver 6b and the signal mentioned above is generated. In FIG. 3b, the first sealing section 1 lies between transmitter 6a and receiver 6b which has the same effect. In FIG. 3c, the two sealing sections land 2 lie one on top of the other, whereby the light beam 6c from the transmitter 6a can reach the receiver 6b and the signal mentioned above is no longer generated. In this embodiment, the signal is a binary value.

In summary, it can be said of the embodiment comprising the additional sensor 6 that not only the transverse position of the packaging material or of the first sealing section 1 or of the second sealing section 2 is detected with respect to the longitudinal direction L but also the relative transverse position of the sealing sections 1, 2 to one another or to the sealing unit.

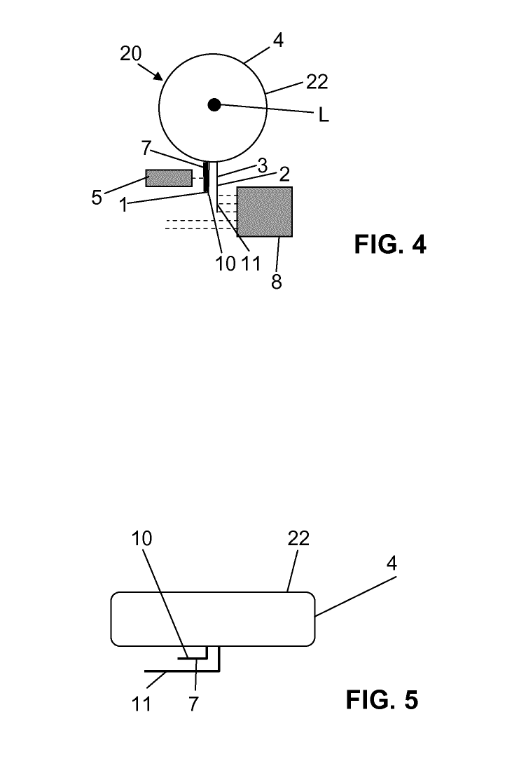

A further embodiment is shown in FIG. 4. The packaging material comprises in this case likewise two sealing sections 1, 2 and at least one cursor 7. The transverse position of the cursor 7 is detected by a first sensor unit 5 in accordance with the description. Furthermore, the embodiment comprises here yet an additional sensor unit 8 with which the transverse position of at least one lateral edge 10, 11 of the packaging material 4 or the sealing section 1, 2 is detected. The effective transverse position of the corresponding lateral edges 10, 11 can be detected with the additional sensor unit 8.

The signal generated using the sensor unit 8 thus corresponds to an amount of the effective transverse position of the lateral edges 10, 11, wherein the signal serves to adjust the transverse position of the packaging material 4 or of the sealing sections 1, 2. The sensor generates an analog signal in this case.

The embodiment according to FIG. 4 has the advantage that the transverse position of both lateral edges 10, 11 or both sealing regions 1, 2 can be adjusted very flexibly. This enables the two lateral edges to lie exactly one on top of the other, and the entire sealing seam comes to lie in a target region with respect to the direction transverse to the running direction L.

The transverse position of the lateral edges 10, 11 can however be controlled such that the film edge without the cursor overlaps the edge with the cursor. The situation thus results that after the seam has been folded down towards the product, only the film edge region without cursor is visible and possible inexact and therefore also unaesthetic overlaps can be masked. This is, for example, shown with the aid of the packaging material in FIG. 5, in which the first lateral edge 10 does not lie directly above the second lateral edge 11.

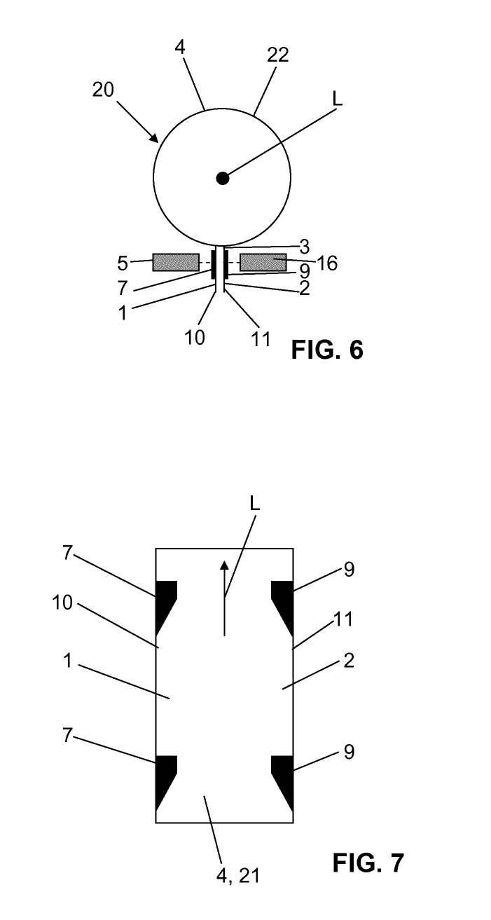

A further embodiment is shown in FIG. 6 and in FIG. 7. The packaging material 4 comprises here likewise two sealing sections 1, 2 and at least one cursor 7. The transverse position of the cursor 7 is detected by a first sensor unit 5 in accordance with the description above. Furthermore, the embodiment comprises here an additional sensor unit 16 with which the transverse position of a second cursor 9 is detected. The additional sensor unit 16 thereby has the same features as the first sensor unit 5, and the second cursor 9 has the same features as the cursors 7 described above. The two sealing sections 1, 2 can be aligned relative to one another as a result of the detection of the two cursors 7, 9.

The first cursor 7 is preferably disposed in the region of the first sealing section 1 and the second cursor 9 in the region of the second sealing section 2.

Because both peripheral regions of the film in the proximity of the respective edge are provided with a cursor 7 and said peripheral regions can be measured on both sides of the sealing seam by respectively one sensor unit 5, 16, a simple and cost effective solution can be provided.

It can thus be said with regard to the embodiments in FIGS. 3, 4, 6 and 7 that a displacement of the entire sealing seam is detected in both directions transverse to the running direction of the film and if necessary is reported and/or corrected.

The embodiments described above have the following advantages:
The transverse position of the sealing sections can be directly measured in the sealing unit for producing the longitudinal seam, which has the advantage that fewer faults occur in the measuring chain between measuring point and sealing unit.
The detection of the transverse position can be implemented very easily and with cost effective sensors which do not damage the film.
Depending on the quality requirements, different variants comprising a different number of sensors and adjustment options can be used.
The number of discarded products can be greatly reduced because a deviation from the target quality can be immediately detected and corresponding measures can be taken.

1. A method for detecting the transverse position of at least one sealing section (1, 2) on a packaging material (4), and/or the transverse position of the packaging material (4), wherein the packaging material (4) is displaced along a running direction (L), wherein the transverse position constitutes the position transverse to the running direction (L), wherein the transverse position of the at least one sealing section (1, 2) or of the packaging material (4) is detected using at least one sensor unit (5), characterized in that the packaging material (4) comprises at least one cursor (7) by means of which the transverse position of the at least one sealing section (1, 2) or of the packaging material (4) is detected, wherein the shape of the cursor (7) changes with respect to a direction, wherein said change is detected by the sensor unit (5) and the transverse position of the packaging material (4) or the at least one sealing section (1, 2) is determined by means of the change.

2. The method according to claim 1, characterized in that a first cursor (7) arranged on the packaging material (4), is detected using a first sensor unit (5), and a second cursor (9) arranged on the packaging material (4) is detected using an additional sensor unit (16).

3. The method according to claim 1, characterized in that the cursor (7) is configured in such a way that a distance (A) which corresponds to a length of the cursor in the running direction (L) changes in conjunction with a change in distance from the lateral edge (10, 11) as viewed transversely with respect to the running direction (L), whereby the transverse position of the sealing section (1, 2) or of the packaging material (4) is determined via the detection of the distance (A).

4. The method according to claim 1, characterized in that the cursor (7, 9) has at least one first detectable measuring edge (12) and a second detectable measuring edge (13), wherein the two edges (10, 11) run at an angle with respect to each other so that a distance (A) from the first measuring edge (12) to the second measuring edge (13) in the running direction (L) changes in conjunction with a change in distance from the lateral edge (10, 11) as viewed transversely with respect to the running direction (L), wherein said transverse position of the sealing section (1, 2) or of the packaging material (4) is determined by means of detecting the distance (A) between the measuring edges (12, 13).

5. The method according to claim 4, characterized in that at least one of the measuring edges (13) runs in an inclined or angular manner relative to the running direction (L) of the packaging material (4).

6. The method according to claim 1, characterized in that the cursor (7) comprises a plurality of stripes (15) of different lengths which are arranged consecutively and at an angle with respect to the running direction (L), wherein the sensor unit detects a different number of stripes (15) depending on the transverse position of the sealing section (1, 2) or of the packaging material (4) and thus determines said transverse position of the sealing sections (1, 2).

7. The method according to claim 1, characterized in that, after detection of the transverse position of the sealing sections (1, 2), the at least two sealing sections (1, 2) are aligned by means of a positioning unit, and in that the transverse position of the sealing sections (1, 2) relative to at least one of one another and the at least one sensor unit is adjusted by the positioning unit on the basis of the detection by the sensor unit (5).

8. The method according to claim 1, characterized in that the transverse position of at least one of the lateral edges (10, 11) of the packaging material (4) or said transverse position of the sealing sections (1, 2) is detected using an additional sensor unit (6), wherein a signal can be generated by the additional sensor unit (6) if one of the lateral edges (10, 11) lies outside of a predefined tolerance field, wherein the signal can serve to adjust the transverse position of the packaging material (4) or of the sealing sections (1, 2).

9. A device for carrying out a method according to claim 1, wherein the device comprises at least one sensor unit (5), characterized in that the packaging material (4) comprises at least one cursor (7) by means of which the transverse position of the at least one sealing section (1, 2) or of the packaging material can be detected relative to the running direction (L), wherein the shape of the cursor changes with respect to a direction, wherein said change is detected by the sensor unit (5) and the transverse position of the packaging material (4) or the at least one sealing section (1, 2) is determined by means of the change.

10. The device according to claim 9, characterized in that the device comprises two sensor units (5, 16) for detecting a cursor (7) arranged on the first sealing region (1) and an additional cursor (9) arranged on the second sealing region (2).

11. The device according to claim 9, characterized in that the cursor (7) is configured in such a way that a distance (A) which corresponds to a length of the cursor in the running direction (L) changes in conjunction with a change in distance from the lateral edge (10, 11) as viewed transversely with respect to the running direction (L), whereby the transverse position of the sealing section (1, 2) or of the packaging material (4) can be determined by detecting the distance (A).

12. The device according to claim 9, characterized in that the cursor (7, 9) has at least one first detectable measuring edge (12) and a second detectable measuring edge (13), wherein both edges (10, 11) run at an angle to one another so that a distance (A) from the first measuring angle (12) to the second measuring angle (13) in the running direction (L) changes in conjunction with a change in distance from the lateral edge (10, 11) as viewed transversely with respect to the running direction (L), wherein said transverse position of the sealing section (1, 2) or of the packaging material (4) can be determined by detecting the distance (A) between the measuring edges (12, 13).

13. The device according to claim 1, characterized in that the device further comprises a sealing station which is disposed downstream with respect to the direction of movement of the packaging material as viewed from the folding device, wherein the sensor unit(s) are disposed at a short distance in front of the sealing station.

14. The device according to claim 1, characterized in that the device comprises an additional sensor unit (6, 8) with which the transverse position of at least one lateral edge (10, 11) of the sealing sections (1, 2) can be detected, wherein a fault signal can be generated by the additional sensor unit (6, 8) if the at least one lateral edge (10, 11) lies outside of a tolerance field and the lateral edge (10, 11) can be moved by means of the positioning unit into the tolerance field or a fault signal can be outputted.

15. (canceled)

16. The method according to claim 1, characterized in that the direction in which the shape of the cursor (7) changes with respect to runs transverse to or at an angle to the running direction (L).

17. The method according to claim 1, characterized in that a first cursor (7) arranged on the packaging material (4), on the first sealing region (1), is detected using a first sensor unit (5), and a second cursor (9) arranged on the packaging material (4), on the second sealing region (2), is detected using an additional sensor unit (16).

18. The method according to claim 1, characterized in that the cursor (7) comprises a plurality of stripes (15) of different lengths which are arranged consecutively and transversely with respect to the running direction (L), wherein the sensor unit detects a different number of stripes (15) depending on the transverse position of the sealing section (1, 2) or of the packaging material (4) and thus determines said transverse position of the sealing sections (1, 2).

19. The method according to claim 1, characterized in that, if applicable, the two sealing sections (1, 2) are sealed by a sealing unit after being aligned by the positioning unit.

20. The method according to claim 1, characterized in that the transverse position of at least one of the lateral edges (10, 11) of the packaging material (4) or said transverse position of the sealing sections (1, 2) is detected using an additional sensor unit (6), wherein a signal is generated by the additional sensor unit (8) which corresponds to the effective transverse position of the lateral edges (10, 11), wherein the signal can serve to adjust the transverse position of the packaging material (4) or of the sealing sections (1, 2).

21. The device according to claim 1, characterized in that the device comprises an additional sensor unit (6, 8) with which the transverse position of at least one lateral edge (10, 11) of the sealing sections (1, 2) can be detected, wherein the transverse position of the at least one lateral edge (10, 11) can be detected using the additional sensor unit (6, 8) and can be corrected in accordance with a predefined target value.
